(19) United States
(12) Patent Application Publication
(10) Pub. No.: US 2025/0368473 A1
(43) Pub. Date: Dec. 4, 2025

(54) CANVAS COVER LAUNCHING DEVICE

(71) Applicant: XIAMEN SUNFAVOR MACHINERY TECHNOLOGY CO.,LTD, Fujian (CN)

(72) Inventors: Yi DING, Fujian (CN); Genwang DAI, Fujian (CN)

(21) Appl. No.: 18/864,907

(22) PCT Filed: Sep. 8, 2023
(86) PCT No.: PCT/CN2023/117665

§ 371 Date: Aug. 13, 2025

(30) Foreign Application Priority Data
Apr. 28, 2023 (CN) 202310479188.1

(51) Int. Cl. B65H 75/44; B65H 18/16; B65H 23/025

(52) U.S. Cl. CPC B65H 75/4457; B65H 18/16; B65H 23/025; B65H 2301/415

(57) ABSTRACT

A canvas cover launching device to prevent crimps on the canvas and achieve flattening effect on the canvas, having a frame and a mounting rack on one side, a hydraulic control valve operated by control levers is on the mounting rack. Two driving plastic rollers and a surface smoothening plastic roller are rotatably connected to the frame from inside to outside of the frame sequentially; corresponding ends of the two driving plastic rollers on a same side are connected to a transmission component enabling the two driving plastic rollers to rotate towards the same direction. A synchronous transmission gearbox is provided to connect corresponding ends on a same side of the surface smoothening plastic roller and one of the two driving plastic rollers more proximal to the surface smoothening plastic roller. Hooked plates are symmetrically provided on two ends of the surface smoothening plastic roller respectively.

### TECHNICAL FIELD

The present invention relates to the field of canvas cover, in particular to a canvas cover launching device.

### BACKGROUND OF THE INVENTION

Canvas is a thick, firm, and closely woven plain weaved cloth woven from hemp or cotton yarns. A canvas may be made into different weights for different purposes such as making tents, camp beds, clothes and shoes. Canvas is generally divided into two kinds, namely coarse canvas and fine canvas. Coarse canvas is also generally known as canvas tarp which has good waterproof performance and which usually serves as a lorry cover, a shelter for outdoor storage space, or for building a tent in the wild.

The use of canvas cover requires a plastic roller to unwind the canvas cover, and the canvas cover is wound by using the plastic roller when the canvas cover is not in use. Since the canvas cover is quite heavy, friction generated between the canvas cover and the items to be covered during winding and unwinding processes may easily cause the canvas cover to crimp, thus resulting in incomplete covering and poor winding effect which may affect subsequent uses of the canvas cover.

### BRIEF SUMMARY OF THE INVENTION

In order to overcome the defects in the prior art, it is an object of the present invention to provide a canvas cover launching device to avoid crimps on the canvas cover which may otherwise affect the covering effect and the winding effect. The present invention can achieve flattening effect on the canvas cover during use.

To fulfil the above object, the present invention provides the following technical solutions:

A canvas cover launching device, comprising a frame, where a mounting rack is provided at one side of the frame; a hydraulic control valve is mounted on the mounting rack; a plurality of control levers are provided on the hydraulic control valve 16 to control activation, deactivation, and directions of hydraulic circuits;

[symbol]

[symbol] two driving plastic rollers and a surface smoothening plastic roller are rotatably connected to the frame sequentially along an axial direction of the frame from inside to outside of the frame; each pair of corresponding ends of the two driving plastic rollers on a same side are connected to a transmission component which enables the two driving plastic rollers to rotate towards a same direction; each of two ends of the surface smoothening plastic roller is provided with an eccentric structure and a rotatable hooked plate which has a shape resembling a ram symbol; the eccentric structure and the rotatable hooked plate at one end of the surface smoothening plastic roller are symmetrically arranged with respect to the eccentric structure and the rotatable hooked plate at another end of the surface smoothening plastic roller; a canvas smoothening roller is provided at a bottom side of the eccentric structure; a synchronous transmission gearbox is provided to connect corresponding ends on a same side of the surface smoothening plastic roller and one of the two driving plastic rollers, and said one of the two driving plastic rollers is the one that is more proximal to the surface smoothening plastic roller; each hooked plate is driven by a hydraulic cylinder to rotate to realize loading and unloading of a roll of canvas; winding and unwinding of the roll of canvas is further realized by cooperative operation of the two driving plastic rollers.

Preferably, each hooked plate comprises a main body plate rotatably connected with a corresponding end of the surface smoothening plastic roller, a first hook and a second hook are provided at two ends of the main body plate respectively; a sloped surface is provided between the first hook and the second hook, and a placing groove configured to place a corresponding end of the roll of canvas is formed between the sloped surface and the second hook.

Preferably, a bottom connection end of the main body plate of each hooked plate is fixedly connected to a movable joint of a corresponding hydraulic cylinder disposed on the frame; the control levers control operation of the hydraulic cylinder through the hydraulic circuits.

Preferably, outer circumferential surfaces of two end portions of the surface smoothening plastic roller are provided with spiral protrusions respectively; and two spiral protrusions at said two end portions of the surface smoothening plastic roller have mutually opposite rotation directions.

Preferably, each of two ends of the surface smoothening plastic roller is provided with said eccentric structure, and the eccentric structure is located between the hooked plate and the frame.

Preferably, a plurality of canvas guide supports erected from a rod of a bottom of the frame are further provided; the canvas guide supports have a T-shape, and the canvas guide supports are evenly distributed between the surface smoothening plastic roller and said one of the two driving plastic rollers more proximal to the surface smoothening plastic roller.

Preferably, the transmission component comprises sprockets provided at said each pair of said corresponding ends of the two driving plastic rollers on a same side respectively, and the sprockets are connected through a chain to transmit motion; the two driving plastic rollers are driven by the hydraulic motor; an input end of said one of the two driving plastic rollers more proximal to the surface smoothening plastic roller is rigidly connected to an output shaft of the synchronous transmission gearbox to achieve synchronous rotation with the surface smoothening plastic roller.

Preferably, a platform is provided at one side of the mounting rack away from the surface smoothening plastic roller, and a counterweight is provided on the platform.

Preferably, one side of the mounting rack is provided with two connection plates configured to connect with a telehandler.

Compared with the prior art, the present invention has the following beneficial effects: operation of the hydraulic cylinder is controlled by the control levers, and the hydraulic cylinder drives the hooked plate to rotate towards a first direction in which the first hook rotates downwardly and the second hook rotates upwardly. Accordingly, each end of the roll of canvas positioned, for example, on the grass, can be hooked by the first hook of a corresponding hooked plate, and then the hydraulic cylinder drives the hooked plate to rotate reversely towards a second direction in which the first hook rotates upwardly and the second hook rotates downwardly, such that the roll of canvas is lifted up, and then the roll of canvas will slide along the sloped surface towards the second hook, until a corresponding end of the roll of canvas is positioned inside the placing groov4, and a surface of the roll of canvas abuts against the two driving plastic rollers. Next, place the frame onto an item to be covered, for example a heap of haystack, to realize automatic launching of the roll of canvas with minimal manual operation, wherein user can use the control levers to control a hydraulic motor which in turns control the synchronous transmission gearbox to rotate to therefore drive the two driving plastic rollers to rotate, rotation of the driving plastic rollers will also drive the roll of canvas to rotate, thereby achieving unwinding of the roll of canvas to cover the haystack.

When the two driving plastic rollers are controlled to rotate reversely to drive the roll of canvas to rotate reversely, the roll of canvas will be wound up from the haystack for storage. During winding and unwinding of the roll of canvas, friction drive to achieve winding and unwinding of the roll of canvas through the two driving plastic rollers may prevent an inconsistent linear speed of the roll of canvas during winding and unwinding due to change in diameter of the roll of canvas, thereby preventing the canvas from being torn to be broken. Further, the canvas during winding and unwinding is subject to smoothening treatment by the surface smoothening plastic roller, and the canvas smoothening roller will be driven by the eccentric structures to oscillate up and down as the surface smoothening plastic roller rotates, such that crimps on the canvas can be eliminated, thereby avoiding incomplete covering and poor winding effect due to the crimps, and effectively improving winding and unwinding efficiency. The surface smoothening plastic roller always rotates in a same direction as said one of the two driving plastic rollers due to the synchronous transmission gearbox, so as to meet the canvas smoothening requirements during both winding and unwinding processes.

After unwinding, the hydraulic cylinder is driven to rotate the hooked plate towards the first direction in which the first hook rotates downwardly and the second hook rotates upwardly, such that the second hook allows the unwound roll of canvas to slide along the sloped surface in a direction towards the first hook, such that the two ends of the roll of canvas slide out from the placing groove, thereby realizing unloading of the roll of canvas, improving the convenience of loading and unloading of the roll of canvas, effectively ensuring the efficiency and effect of canvas covering, and effectively reducing the amount and intensity of manual operation.

### BRIEF DESCRIPTION OF THE DRAWINGS

FIG. 1 is a schematic perspective structural view of a canvas cover launching device according to an embodiment of the present invention;

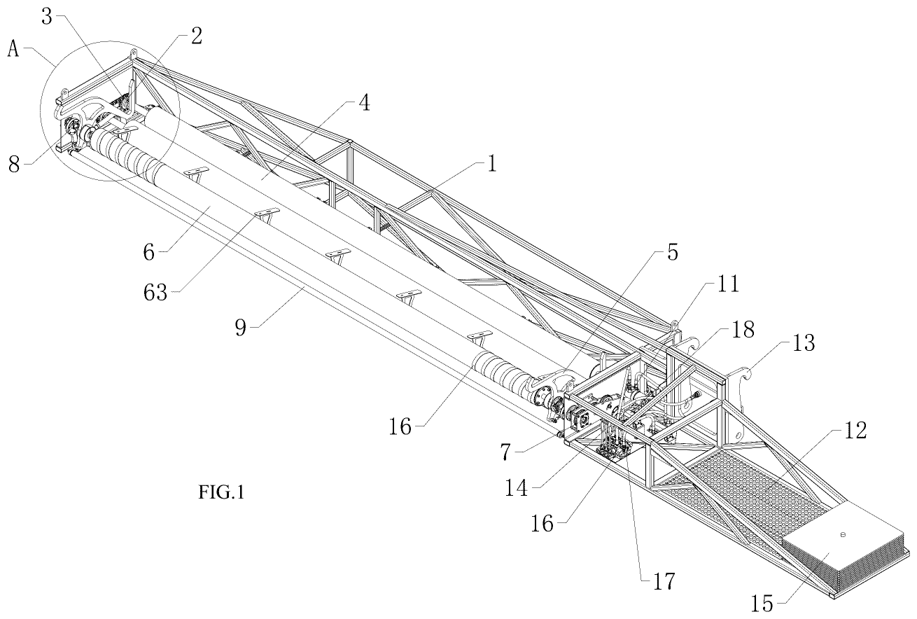

FIG. 2 is another schematic perspective structural view of the canvas cover launching device according to an embodiment of the present invention; and

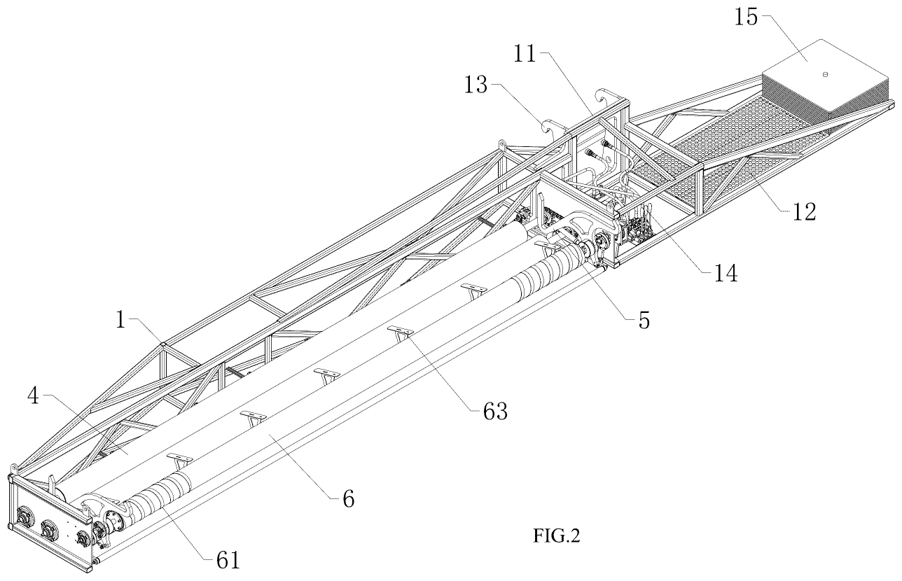

FIG. 3 is an enlarged view of portion A in FIG. 1 according to an embodiment of the present invention.

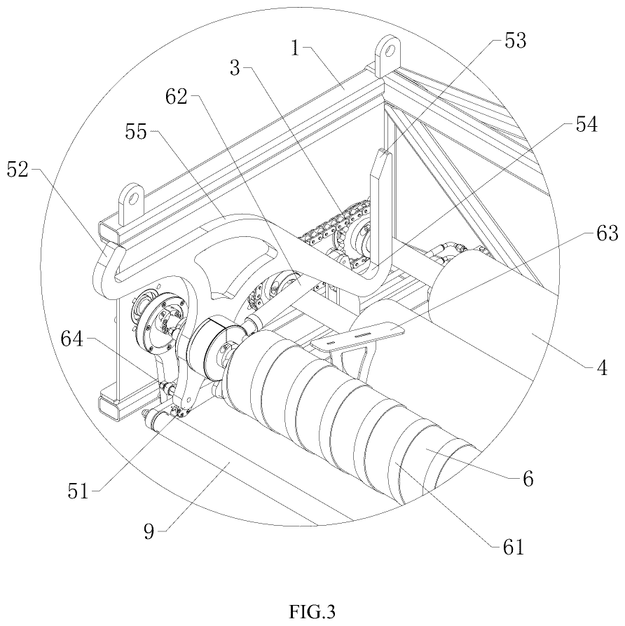

### REFERENCE NUMERALS

1—frame; 11—mounting rack; 12—platform; 13—connection plate; 14—control lever; 15—counterweight; 16—hydraulic control valve; 2—sprocket; 3—chain; 4—driving plastic roller; 5—hooked plate; 51—main body plate; 52—first hook; 53—second hook; 54—placing groove; 55—sloped surface; 6—surface smoothening plastic roller; 61—spiral protrusion; 62—hydraulic cylinder; 63—canvas guide support; 64—movable joint; 7—synchronous transmission gearbox; 8—eccentric structure; and 9—canvas smoothening roller.

### DETAILED DESCRIPTION OF THE INVENTION

The technical solutions of the present invention are further explained by the detailed description with reference to the attached drawings.

A canvas cover launching device, comprising a frame 1, where a mounting rack 11 is provided at one side of the frame 1; a hydraulic control valve 16 is mounted on the mounting rack 11; a plurality of control levers 14 are provided on the hydraulic control valve 16 configured to control activation, deactivation, and directions of hydraulic circuits.

Two driving plastic rollers 4 and a surface smoothening plastic roller 6 are rotatably connected to the frame 1 sequentially along an axial direction of the frame 1 from inside to outside of the frame 1; each pair of corresponding ends of the two driving plastic rollers 4 on a same side are connected to a transmission component which enables the two driving plastic rollers to rotate towards a same direction; each of two ends of the surface smoothening plastic roller 6 is provided with an eccentric structure 8 and a rotatable hooked plate 5 which has a shape resembling a ram symbol; the eccentric structure 8 and the rotatable hooked plate 5 at one end of the surface smoothening plastic roller 6 are symmetrically arranged with respect to the eccentric structure 8 and the rotatable hooked plate 5 at another end of the surface smoothening plastic roller 6. A canvas smoothening roller 9 is provided at a bottom side of the eccentric structure 8; rotation of the surface smoothening plastic roller 6 is transmitted to the canvas smoothening roller 9 through the eccentric structures 8 at two ends of the surface smoothening plastic roller 6, such that the canvas smoothening roller 9 will oscillate up and down to realize a canvas smoothening effect. A synchronous transmission gearbox 7 is provided to connect corresponding ends on a same side of the surface smoothening plastic roller 6 and one of the two driving plastic rollers 4, and said one of the two driving plastic rollers 4 is the one that is more proximal to the surface smoothening plastic roller 6. Each hooked plate 5 is driven by a hydraulic cylinder 62 to rotate to realize loading and unloading of a roll of canvas; winding and unwinding of the roll of canvas is further realized by cooperative operation of the two driving plastic rollers 4. A platform 12 is provided at one side of the mounting rack 11 away from the surface smoothening plastic roller 6, and a counterweight 15 is provided on the platform 12.

Each hooked plate 5 comprises a main body plate 51 rotatably connected with a corresponding end of the surface smoothening plastic roller 6, a first hook 52 and a second hook 53 are provided at two ends of the main body plate 51 respectively; a sloped surface 55 is provided between the first hook 52 and the second hook 53, and a placing groove 54 for placing a corresponding end of the roll of canvas is formed between the sloped surface 55 and the second hook 53. Operation of the hydraulic cylinder 62 is controlled by the control levers 14, and the hydraulic cylinder 62 drives the hooked plate 5 to rotate towards a first direction in which the first hook 52 rotates downwardly and the second hook 53 rotates upwardly. Accordingly, each end of the roll of canvas positioned, for example, on the grass, can be hooked by the first hook 52 of a corresponding hooked plate 5, and then the hydraulic cylinder 62 drives the hooked plate 5 to rotate reversely towards a second direction in which the first hook 52 rotates upwardly and the second hook 53 rotates downwardly, such that the roll of canvas is lifted up, and then the roll of canvas will slide along the sloped surface 55 towards the second hook 53, until a corresponding end of the roll of canvas is positioned inside the placing groove 54, and a surface of the roll of canvas abuts against the two driving plastic rollers 4. Next, place the frame 1 onto an item to be covered, for example a heap of haystack, to realize automatic launching of the roll of canvas with minimal manual operation, wherein user can use the control levers 14 to control a hydraulic motor which in turns control the synchronous transmission gearbox 7 to rotate to therefore drive the two driving plastic rollers 4 to rotate, rotation of the driving plastic rollers 4 will also drive the roll of canvas to rotate, thereby achieving unwinding of the roll of canvas to cover the haystack. When the hydraulic motor is controlled to rotate reversely, the two driving plastic rollers 4 rotate reversely to drive the roll of canvas to rotate reversely, thereby winding up the roll of canvas from the haystack for storage. During winding and unwinding of the roll of canvas, friction drive to achieve winding and unwinding of the roll of canvas through the two driving plastic rollers 4 may prevent an inconsistent linear speed of the roll of canvas during winding and unwinding due to change in diameter of the roll of canvas, thereby preventing the canvas from being torn to be broken. Further, the canvas during winding and unwinding is subject to smoothening treatment by the surface smoothening plastic roller 6, and the canvas smoothening roller 9 will be driven by the eccentric structures 8 to oscillate up and down as the surface smoothening plastic roller 6 rotates, such that crimps on the canvas can be eliminated, thereby avoiding incomplete covering and poor winding effect due to the crimps, and effectively improving winding and unwinding efficiency. The surface smoothening plastic roller 6 always rotates in a same direction as said one of the two driving plastic rollers due to the synchronous transmission gearbox 7, so as to meet the canvas smoothening requirements during both winding and unwinding processes. After unwinding, the hydraulic cylinder 62 is driven to rotate the hooked plate 5 towards the first direction in which the first hook 52 rotates downwardly and the second hook 53 rotates upwardly, such that the second hook 53 allows the unwound roll of canvas to slide along the sloped surface 55 in a direction towards the first hook 52, such that the two ends of the roll of canvas slide out from the placing groove 54, thereby realizing unloading of the roll of canvas, improving the convenience of loading and unloading of the roll of canvas, effectively ensuring the efficiency and effect of canvas covering, and effectively reducing the amount and intensity of manual operation.

As a possible embodiment of the present invention, preferably, a bottom connection end of the main body plate 51 of each hooked plate 5 is fixedly connected to a movable joint 64 of a corresponding hydraulic cylinder 62 disposed on the frame 1; the control levers 14 control operation of the hydraulic cylinder 62 through the hydraulic circuits; the hydraulic cylinder 62 drives the main body plate 51 through the movable joint 64 so that the main body plate 51 rotates about the corresponding end of the surface smoothening plastic roller 6, where during rotation of the main body plate 51 towards the second direction, the roll of canvas is lifted by the first hook 52 and slides towards the second hook 53 along the sloped surface 55 and eventually rests in the placing groove 54, so as to realize loading of the roll of canvas. When the hydraulic cylinder 62 is operated towards a reverse direction where the main body plate 51 rotates reversely towards the first direction, the roll of canvas can be unloaded. Accordingly, the present invention improves the convenience of loading and unloading the roll of canvas, and facilitates the covering of, for example a heap of haystack, by unwinding the roll of canvas.

As a possible embodiment of the present invention, preferably, outer circumferential surfaces of two end portions of the surface smoothening plastic roller 6 are provided with spiral protrusions 61 respectively; and two spiral protrusions 61 at said two end portions of the surface smoothening plastic roller 6 have mutually opposite rotation directions. The surface smoothening plastic roller 6 always rotates in a same direction as said one of the two driving plastic rollers through the synchronous transmission gearbox 7, and so an outward component force is generated on the canvas due to the friction produced by sliding of the canvas on the spiral protrusions 61, accordingly, the purpose of canvas smoothening effect is achieved.

As a possible embodiment of the present invention, preferably, each of two ends of the surface smoothening plastic roller 6 is provided with said eccentric structure 8, and the eccentric structure 8 is located between the hooked plate 5 and the frame 1. The eccentric structure 8 drives the canvas smoothening roller 9 to oscillate up and down to process the canvas such that the crimps are eliminated in advance, thereby ensuring the winding and unwinding effects.

As a possible embodiment of the present invention, preferably, a plurality of canvas guide supports 63 erected from a rod of a bottom of the frame 1 are further provided; the canvas guide supports 63 has a T-shape, and the canvas guide supports 63 are evenly distributed between the surface smoothening plastic roller 6 and said one of the two driving plastic rollers 4 more proximal to the surface smoothening plastic roller 6, so as to guide the winding and unwinding of the roll of canvas and avoid displacement during winding and unwinding processes.

As a possible embodiment of the present invention, preferably, the transmission component comprises sprockets 2 provided at said each pair of said corresponding ends of the two driving plastic rollers 4 on a same side respectively, and the sprockets 2 are connected through a chain 3 to transmit motion; the two driving plastic rollers 4 are driven by the hydraulic motor; an input end of said one of the two driving plastic rollers 4 more proximal to the surface smoothening plastic roller 6 is rigidly connected to an output shaft of the synchronous transmission gearbox 7, and synchronous rotation of the two driving plastic rollers 4 towards a same direction is realized by utilizing the sprockets 2 in cooperation with the chain 3 so as to realize the winding and unwinding of the roll of canvas.

As a possible embodiment of the present invention, preferably, one side of the mounting rack 11 is provided with two connection plates 13 configured to connect with a telehandler. The connection plates 13 are used to realize fast connection with the telehandler, which facilitates mobility and the ease of mounting and dismounting.

While the present invention has been described with reference to the preferred embodiments, it will be understood by those skilled in the art that various changes and alternative configurations achieving equivalent technical effects may be made to the features and embodiments without departing from the spirit and scope of the present invention. The present invention is not limited by the specific embodiments disclosed herein, and other embodiments that fall within the claims of the present application are within the scope of protection of the present invention.

1. A canvas cover launching device, comprising a frame (1), where a mounting rack (11) is provided at one side of the frame (1); a hydraulic control valve (16) is mounted on the mounting rack (11); a plurality of control levers (14) are provided on the hydraulic control valve (16) to control activation, deactivation, and directions of hydraulic circuits (17); two driving plastic rollers (4) and a surface smoothening plastic roller (6) are rotatably connected to the frame (1) sequentially along an axial direction of the frame (1) from inside to outside of the frame (1); each pair of corresponding ends of the two driving plastic rollers (4) on a same side are connected to a transmission component which enables the two driving plastic rollers (4) to rotate towards a same direction; each of two ends of the surface smoothening plastic roller (6) is provided with an eccentric structure (8) and a hooked plate (5) which is rotatable; the eccentric structure (8) and the rotatable hooked plate (5) at one end of the surface smoothening plastic roller (6) are symmetrically arranged with respect to the eccentric structure (8) and the hooked plate (5) at another end of the surface smoothening plastic roller (6); a canvas smoothening roller (9) is provided at a bottom side of the eccentric structure (8); rotation of the surface smoothening plastic roller (6) is transmitted to the canvas smoothening roller (9) through eccentric structures (8) at two ends of the surface smoothening plastic roller (6), such that the canvas smoothening roller (9) is capable of oscillating up and down to realize a canvas smoothening effect; a synchronous transmission gearbox (7) is provided to connect corresponding ends on a same side of the surface smoothening plastic roller (6) and one of the two driving plastic rollers (4), and said one of the two driving plastic rollers (4) is the one that is more proximal to the surface smoothening plastic roller (6); each hooked plate (5) is driven by a hydraulic cylinder (62) to rotate.

2. The canvas cover launching device of claim 1, wherein each hooked plate (5) comprises a main body plate (51) rotatably connected with a corresponding end of the surface smoothening plastic roller (6), a first hook (52) and a second hook (53) are provided at two ends of the main body plate (51) respectively; a sloped surface (55) is provided between the first hook (52) and the second hook (53), and a placing groove (54) configured to place a corresponding end of the roll of canvas is formed between the sloped surface (55) and the second hook (53).

3. The canvas cover launching device of claim 2, wherein a bottom connection end of the main body plate (51) of each hooked plate (5) is fixedly connected to a movable joint of a corresponding hydraulic cylinder (62) disposed on the frame (1); the control levers (14) control operation of the hydraulic cylinder (62) through the hydraulic circuits (17).

4. The canvas cover launching device of claim 1, wherein outer circumferential surfaces of two end portions of the surface smoothening plastic roller (6) are provided with spiral protrusions (61) respectively; and two spiral protrusions (61) at said two end portions of the surface smoothening plastic roller (6) have mutually opposite rotation directions.

5. The canvas cover launching device of claim 1, wherein each eccentric structure (8) is located between a corresponding hooked plate (5) and the frame (1).

6. The canvas cover launching device of claim 1, further comprising a plurality of canvas guide supports (63) erected from a bottom of the frame (1); the canvas guide supports (63) have a T-shape, and the canvas guide supports (63) are evenly distributed between the surface smoothening plastic roller (6) and said one of the two driving plastic rollers (4) more proximal to the surface smoothening plastic roller (6).

7. The canvas cover launching device of claim 1, wherein the transmission component comprises sprockets (2) provided at said each pair of said corresponding ends of the two driving plastic rollers (4) on a same side respectively, and the sprockets (2) are connected through a chain (3) to transmit motion; the two driving plastic rollers (4) are driven by the hydraulic motor (18); an input end of said one of the two driving plastic rollers (4) more proximal to the surface smoothening plastic roller (6) is rigidly connected to an output shaft of the synchronous transmission gearbox (7) to achieve synchronous rotation with the surface smoothening plastic roller (6).

8. The canvas cover launching device of claim 1, wherein a platform (12) is provided at one side of the mounting rack (11) away from the surface smoothening plastic roller (6), and a counterweight (15) is provided on the platform (12).

9. The canvas cover launching device of claim 1, wherein one side of the mounting rack (11) is provided with two connection plates (13) configured to connect with a telehandler.
